(19) United States
(12) Patent Application Publication
(10) Pub. No.: US 2017/0053384 A1
(43) Pub. Date: Feb. 23, 2017

(54) IMAGE-PROCESSING DEVICE, IMAGE-CAPTURING DEVICE, IMAGE-PROCESSING METHOD, AND STORAGE MEDIUM

(71) Applicant: NEC Corporation, Minato-ku, Tokyo (JP)

(72) Inventor: Masato TODA, Tokyo (JP)

(73) Assignee: NEC Corporation, Minato-ku, Tokyo (JP)

(21) Appl. No.: 15/119,886

(22) PCT Filed: Feb. 26, 2015
(86) PCT No.: PCT/JP2015/001000

§ 371 Date: Aug. 18, 2016

(30) Foreign Application Priority Data
Mar. 6, 2014 (JP) 2014-044438

(51) Int. Cl. G06T 5/00; H04N 5/235; G06K 9/46; H04N 5/225; G06T 7/40

(52) U.S. Cl. CPC G06T 5/001; H04N 5/2256; G06T 7/408; G06K 9/4661; H04N 5/2353; G06T 7/407; G06T 2207/10024

(57) ABSTRACT

An image-processing device according to the present invention includes: a reflected light restoration unit that restores reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and an illumination light restoration unit that restores the illumination light based on the restored reflected-light, and generates a first output image in which the captured image is restored based on the restored illumination light and the captured image.

### REFERENCE TO RELATED APPLICATION

This application is a National Stage Entry of PCT/JP2015/001000 filed on Feb. 26, 2015, which is based upon and claims the benefit of priority from Japanese patent application No. 2014-044438, filed on Mar. 6, 2014, the disclosures of all of which are incorporated herein in their entirety by reference.

### TECHNICAL FIELD

The present invention relates to an image-processing device, an image-capturing device, an image-processing method, and a storage medium for storing a program.

### BACKGROUND ART

There is a case that, in an outdoor imaging environment, fine particles which drift in the air, such as water particles which are generated in a bad weather like fog, mist, haze or the like, smoke, sand dust, powder dust, or the like, are included (hereinafter, fine particles are collectively called ‘haze or the like’ in some cases). In the imaging environment, as shown in FIG. 7, reflected light from an object to be imaged is diffused by the particles existing in the air while propagating through a path to a camera which is an image-capturing device. As a result, the reflected light from the object is attenuated to reach a camera sensor. Similarly, an ambient light is diffused by the particles in the air to reach the camera sensor. Therefore, light (observed light) which is irradiated to the camera sensor is mixture light of the attenuated reflected-light from the object and the diffused ambient light. As a result, a captured image in the camera sensor is an image which includes a degraded component such as white haze.

The observed light I(x,λ) of a wavelength λ at a pixel position x of the camera sensor is expressed such as equation (1) by using the reflected light J(x,λ) and the ambient light A(λ) at the same position. Here, “t(x,λ)” in equation (1) expresses indicates transmittance of the reflected light. In the case that a state of the ambient air is uniform, t(x,λ) is expressed such as equation (2) by using a diffusion coefficient (k(λ)) per a unit distance, and a distance (d(x)) from the camera sensor to the object.

I(x,λ)=t(x,λ)·J(x,λ)+(1−t(x,λ))·A(λ) (1)

t(x,λ)=exp(−k(λ)·d(x)) (2)

Moreover, in the case of a wavelength band of the visible light, it is conceivable that diffusion due to the particles in the air is the same even if the wavelength is different. Therefore, the observed light I(x,λ) and the transmittance t(x) are expressed such as equation (3) and equation (4).

I(x,λ)=t(x)·J(x,λ)+(1−t(x))·A(λ) (3)

t(x)=exp(−k·d(x)) (4)

An image restoration (estimation) technology, which removes degradation of an image (influence of haze or the like) caused by the particles in the air from an image captured in this environment, estimates the reflected light J(x,λ), which is not attenuated and comes from the object, from the observed light I(x,λ). Concretely, the image restoration technology estimates the transmittance t(x) of the reflected light is estimated and calculates the reflected light J(x,λ) such as equation (5).

$$J ( x , λ ) = \frac{1}{t ( x )} \cdot I ( x , λ ) - \frac{1 - t ( x )}{t ( x )} \cdot A ( λ ) \qquad ( 5 )$$

The above-mentioned image restoration (estimation) technology requires estimating two pieces of information of the reflected light J(x,λ) and the transmittance t(x) for each of pixels from the observed light I(x,λ). Therefore, the above-mentioned image restoration technology becomes an ill-posed problem of which a solution is not found. Therefore, some prior knowledge on the environment is required for estimating the optimum solution of the reflected light J(x,λ) and the transmittance t(x) in the above-mentioned image restoration technology.

Some technologies for removing influence of degradation of the image based on the haze or the like by estimating the reflected light or the transmittance have been proposed so far. Out of those, methods executing correction processing based on one image will be described with reference to NPL 1 and NPL 2.

A method described in NPT 1 uses statistical knowledge as prior knowledge. The knowledge is a knowledge that, in a natural image which is not in a hazy situation or the like, there is a pixel, value of which is 0, in any one of channels among the RGB color channels around a focused pixel. Furthermore, the method described in NPT 1 is a method which generates a restored image based on the statistical knowledge. Therefore, when there is no pixel, value of which is 0, in any channels around the focused pixel, the method described in NPT 1 regards, as influence of superposition of the ambient light based on the haze or the like, that a value does not become 0. Then, the method described in NPT 1 calculates the transmittance based on a value of the channel of the pixel around the focused pixel.

A method described in NPL 2 uses no correlation between texture of an object and a distance to the object (degree of superposition of the ambient light based on a process of degradation due to the haze or the like) as the prior knowledge. Then, the method described in NPL 2 is a method which separates the reflected light and the ambient light by focusing the above-mentioned un-correlation.

### CITATION LIST

### Patent Literature

### Non Patent Literature

[NPL 1] Kaiming He, Jian Sun, and Xiaou Tang, “Single Image Haze Removal Using Dark Channel Prior”, IEEE Transactions on Pattern Analysis and Machine Intelligence, Volume 33, Issue 12, Sep. 9, 2010
[NPL 2] Raanan Fattal, “Single Image Dehazing”, ACM Transactions on Graphics, Volume 27, Issue 3, August 2008 (ACM SIGGRAPH 2008)

### SUMMARY OF INVENTION

### Technical Problem

The methods of removing the degraded component due to the haze or the like described in the above-mentioned NPL 1 and NPL 2 assumes that the ambient light is illuminated uniformly and illumination quantities of the ambient light at each position within the imaging environment are same. However, when image-capturing by using illumination light such as a lamp, illumination quantities of the ambient light at each position within the imaging environment are not the same. Therefore, when capturing by using the illumination light, the methods described in NPL 1 and NPL 2 have a problem in which the methods do not work correctly when removing the degraded component of the captured image and restoring the image.

For example, as shown in FIG. 8, as the object to be imaged becomes farther from the camera and the lamp, the illumination light is more attenuated due to the particles in the air on a path. As the object exists farther away, the weaker illumination light is illuminated. That is, an illumination quantity of the illumination light by the lamp at each position within the imaging environment is changed. Therefore, the imaging environment does not match with model equations of equations (1) and (3). As mentioned above, the methods is described in NPL 1 and NPL 2 have the problem in that it is impossible to appropriately correct the captured image by using the illumination light.

The present invention is conceived by taking the above-mentioned problem into consideration. An object of the present invention is to provide an image-processing device, an image-capturing device, an image-processing method, and a storage medium storing a program which can appropriately correct degradation of an image captured in an environment where illumination light is not uniformly illuminated at each position within an imaging environment.

### Solution to Problem

An image-processing device according to one aspect of the present invention includes: a reflected light restoration unit that restores reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and an illumination light restoration unit that restores the illumination light based on the restored reflected-light, and generates a first output image in which the captured image is restored based on the restored illumination light and the captured image.

An image-capturing device according one aspect of the present invention includes: the above-mentioned image-processing device; a reception unit that captures or receives the captured image; and an output unit that outputs the first to the third output images

An image-processing method according to one aspect of the present invention includes: restoring reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and restoring the illumination light based on the restored reflected-light, and generating a first output image in which the captured image is restored based on the restored illumination light and the captured image.

A computer readable non-transitory storage medium according to one aspect of the present invention embodying a program, the program causing a computer to perform a method, the method comprising: restoring reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and restoring the illumination light based on the restored reflected-light, and generating a first output image in which the captured image is restored based on the restored illumination light and the captured image.

### Advantageous Effects of Invention

The present invention can bring about an advantageous effect of appropriately correcting degradation of the image which is an image captured in the environment where the illumination light is not illuminated uniformly.

### BRIEF DESCRIPTION OF DRAWINGS

FIG. 1 is a block diagram showing an example of a configuration of an image-capturing device according to a first exemplary embodiment of the present invention.

FIG. 2 is a block diagram showing an example of a configuration of an image-processing device according to the first exemplary embodiment.

FIG. 3 is a block diagram showing an example of a configuration of a haze removal unit according to the first exemplary embodiment.

FIG. 4 is a block diagram showing an example of a configuration of an image-processing device according to a second exemplary embodiment.

FIG. 5 is a block diagram showing an example of a configuration of an image-processing device according to a third exemplary embodiment.

FIG. 6 is a block diagram showing an example of a configuration of an image-capturing device according to a fourth exemplary embodiment.

FIG. 7 is a model diagram showing an example of an imaging environment where the ambient light is illuminated.

FIG. 8 is a model diagram showing an example of an imaging environment where illumination light is illuminated.

FIG. 9 is a block diagram showing an example of a configuration of an information-processing device according to a modification.

### DESCRIPTION OF EMBODIMENTS

Next, exemplary embodiments of the present invention will be described with reference to drawings.

The respective drawings illustrate the exemplary embodiments of the present invention. However, the present invention is not limited to the illustrations of respective drawings. The same number is allocated to the same configuration in the respective drawings, and their repeated description may be omitted.

Moreover, in the drawings used in the following description, a configuration of a part not related to the description of the present invention is omitted and may not be depicted in the drawings.

### First Exemplary Embodiment

First, an image-capturing device 4 according to a first exemplary embodiment of the present invention will be described.

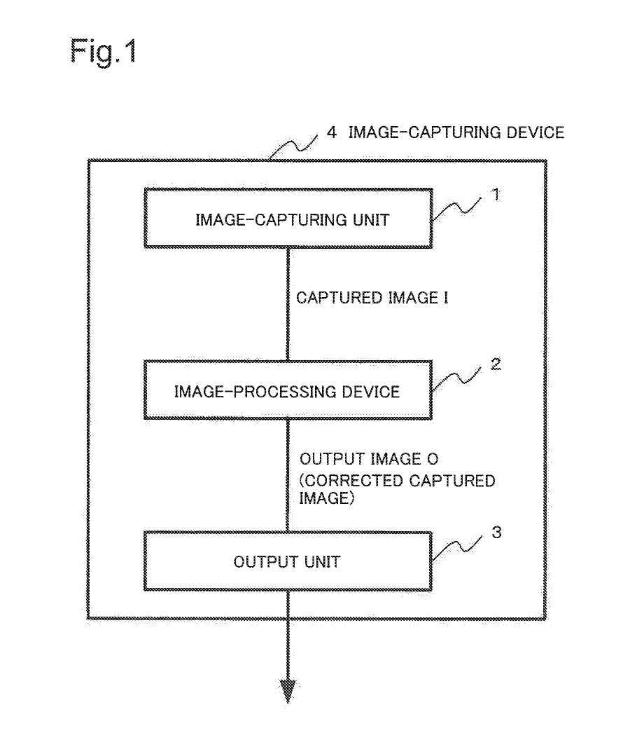

FIG. 1 is a block diagram showing an example of a configuration of the image-capturing device 4 according to the first exemplary embodiment of the present invention.

The image-capturing device 4 according to the first exemplary embodiment includes an image-capturing unit 1, an image-processing device 2, and an output unit 3.

The image-capturing unit 1 captures a captured image (I(x,λ)) of an object to be imaged. The image-capturing unit 1 is constituted, for example, so as to include an image sensor using a Charge Coupled Device (CCD) or a Complementary Metal Oxide Semiconductor (CMOS). The image-capturing unit 1 may receive the captured image of the object from image-capturing equipment which is not shown in the drawing. Therefore, the image-capturing unit 1 is also called a reception unit. Since the captured image I(x,λ) is generated based on light which is detected by the image sensor, the captured image I(x,λ) is also corresponding to the observed light I(x,λ) which is described in Background Art.

The image-processing device 2 corrects degradation (for example, degradation due to haze or the like) of the captured image I(x,λ) based on at least any one of attenuation or diffusion of illumination light illuminated to the object by particles (for example, haze or the like) in the air. Concretely, the image-processing device 2 restores an attenuated component of reflected light from the object based on diffusion light of the illumination light caused by the particles in the air. Then, the image-processing device 2 restores the attenuated component of the illumination light based on the diffusion light and the restored reflected-light. Furthermore, the image-processing device 2 corrects (restores) the captured image I(x,λ) based on the restored illumination light to generate an output image O(x,λ). Therefore, the image-processing device 2 may be called a correction unit. The output image O(x,λ) is also a corrected captured-image. The output image O(x,λ) is also a degradation removal image.

The output unit 3 outputs the output image O(x,λ) generated by the image-processing device 2 generates, that is, the corrected captured-image I(x,λ). The output unit 3 is, for example, a display or a printer.

Next, the image-processing device 2 will be described in detail.

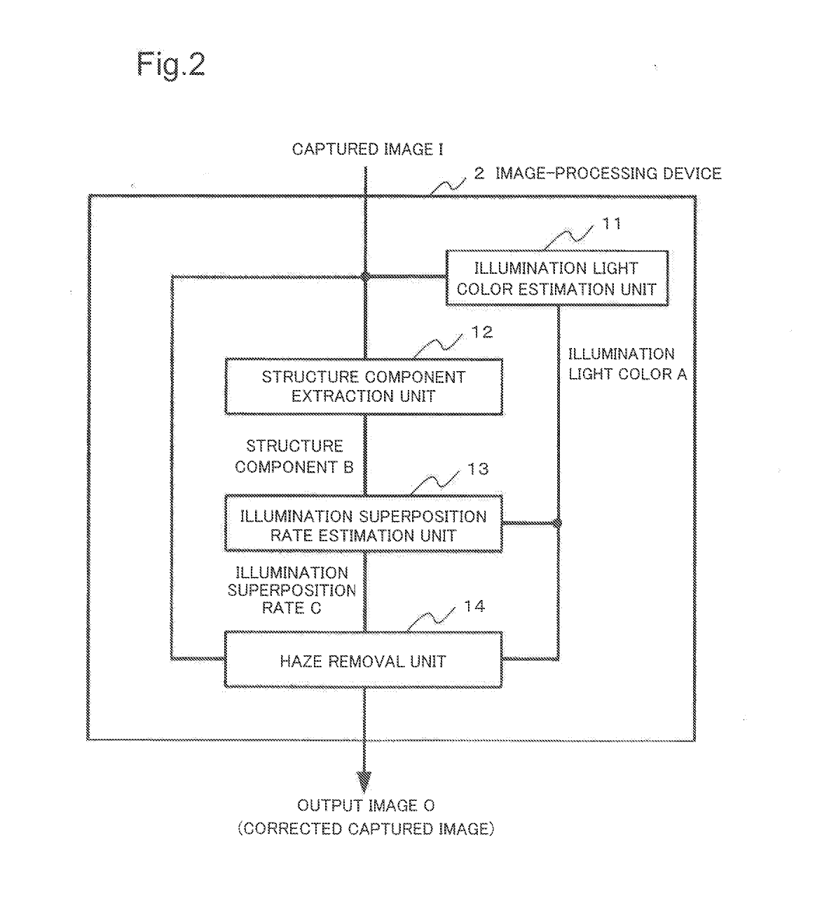

FIG. 2 is a block diagram showing the image-processing device 2 according to the first exemplary embodiment.

The image-processing device 2 of the first exemplary embodiment includes an illumination light color estimation unit 11, a structure component extraction unit 12, an illumination superposition rate estimation unit 13, and a haze removal unit 14.

The illumination light color estimation unit 11 estimates an illumination light color A(λ) which is information on a color of the illumination light, as the ambient light in an imaging environment. A method of estimating the illumination light color A(λ) in the present exemplary embodiment is not limited particularly. As one of the methods of estimating the illumination light color A(λ), there is a method of generating an intensity histogram of quantities of light for each wavelength, and making the values of quantities of light, which are at top a % intensity of wavelengths, the illumination light color A(λ) by using a predetermined parameter (α). Alternatively, the present exemplary embodiment may use the method which is described in NPL 1 or NPL 2.

The structure component extraction unit 12 removes a fine change in the image from captured image I(x,λ), and extracts comprehensive structure (for example, color or brightness of a flat area portion of the image) in the image configured with the flat area portion, in which a change of a pixel value is few, and a strong edge portion, in which the change is large. Hereinafter, the comprehensive structure is called a structure component (B(x,λ)). A method of extracting the structure component B(x,λ) in the present exemplary embodiment is not limited particularly. As an example of the method of extracting the structure component B(x,λ), there is a method which uses the all-variation norm minimization. The method which uses the all-variation norm minimization is a method related to a technology which removes a vibration component in the image. This method extracts the structure component B(x,λ) of the image based on information which is acquired by solving the minimization problem expressed such as equation (6) by using the image (in this case, captured image I(x,λ)). Here, μ is a predetermined parameter for controlling a quantity of vibration to be removed. The method which uses the all-variation norm minimization can not only remove a fine vibration component but also remove a vibration which has a long period of time (low frequency) by combining the multi-resolution analysis. An integral of first term in a parenthesis of equation (6) is an integral of all variations of the structure component B(x,λ) on the xy plane. A second term is a multiplication of μ/2 and a square of two-dimensional norm of a difference between the captured image I(x,λ) and the structure component B(x,λ). In equation (6), description of ‘(x,λ)’ is omitted. ‘U’ under ‘min’ is a mark (cup) expressing that all are included. That is, equation (6) indicates the minimum out of all cases which can be imagined.

$${min}_{U} ( \int \vert ∇ B \vert d x d y - \frac{λ}{2} {‖ I - B ‖}_{2}^{2} ) \qquad ( 6 )$$

As an illumination superposition rate c(x), the illumination superposition rate estimation unit 13 estimates a ratio of the illumination light at a time of emission to the illumination light reaching a camera sensor as a result of diffused by the particles in the air for each of pixels by using the illumination light color A(λ) and the structure component B(x,λ). That is, the illumination superposition rate estimation unit 13 estimates a degree of influence of attenuation or diffusion of the illumination light which is caused by the particles in the air. As mentioned above, the illumination superposition rate c(x) is a value indicating the degree of influence of attenuation or diffusion of the illumination light which is caused by the particles in the air.

An example of an equation for calculating the illumination superposition rate c(x) at a pixel position x is expressed such as equation (7). However, and k₁ is a parameter indicating the predetermined ratio.

$$c ( x ) = {k}_{1} \cdot {min}_{∀ λ} \frac{B ( x , λ )}{A ( λ )} \qquad ( 7 )$$

For example, the ratio k₁ may be changed so as to be expressed such as the equation (8) by using luminance lumi(x) around a focused pixel. However, k₁ₘₐₓ and th₁ are predetermined parameters.

$${k}_{1} ( x ) = \{ \begin{matrix}{k}_{1 max} & if lumi ( x ) > {th}_{1} \\ {k}_{1 max} \cdot \frac{lumi ( x )}{{th}_{1}} & otherwise\end{matrix} \qquad ( 8 )$$

Two examples of calculating the luminance lumi(x) are expressed such as equation (9) and equation (10).

$$\begin{matrix}lumi ( x ) = {max}_{∀ λ} ( B ( x , λ ) ) & ( 9 ) \\ lumi ( x ) = \frac{{max}_{∀ λ} ( B ( x , λ ) ) + {min}_{∀ λ} ( B ( x , λ ) )}{2} & ( 10 )\end{matrix}$$

When the illumination superposition rate c(x) exceeds a predetermined maximum value th₂, the illumination superposition rate c(x) may be adjusted so as not to exceed the maximum value by be performed a clip processing such as equation (11).

$$c ( x ) = \{ \begin{matrix}c ( x ) & if c ( x ) < {th}_{2} \\ {th}_{2} & otherwise\end{matrix} \qquad ( 11 )$$

The haze removal unit 14 generates the output image O(x,λ) which is an image removing and correcting a degraded component due to the haze or the like based on the captured image I(x,λ), the illumination light color A(λ), and the illumination superposition rate c(x). That is, the haze removal unit 14 removes the diffusion light, due to the particles in the air, of the illumination light illuminated to the object to be imaged, and restores the attenuated component of the reflected light of the object. Furthermore, the haze removal unit 141 generates the output image O(x,λ) based on restoration of the attenuation component of the illumination light illuminated to the object.

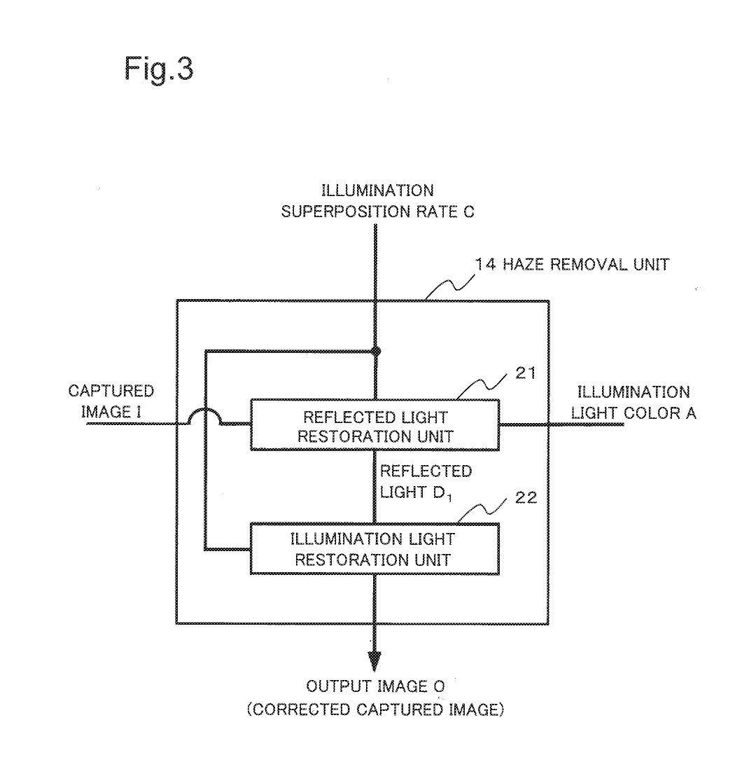

Therefore, the haze removal unit 14, as shown in FIG. 3, includes a reflected light restoration unit 21 and an illumination light restoration unit 22.

The reflected light restoration unit 21 removes the diffusion light due to the illumination light from the captured image I(x,λ), and furthermore restores the attenuation of the reflected light caused by the particles in the air on a path from the object to the camera sensor. Based on the above-mentioned processing, the reflected light restoration unit 21 restores the reflected light D₁(x,λ) on a surface of the object. As an example of a concrete method of restoration of the reflected light D₁(x,λ), there is a method of calculating the reflected light D₁(x,λ) such as equation (12) by regarding a relation among the reflected light D₁(x,λ), the input image I(x,λ), the illumination light color A(λ), and the illumination superposition rate c(x) as being thoroughly approximate to the environment expressed such as equation (1).

$${D}_{1} ( x , λ ) = \frac{1}{1 - c ( x )} ( I ( x , λ ) - c ( x ) \cdot A ( λ ) ) \qquad ( 12 )$$

In order to reduce influence caused by a difference from the past imaging environment or an estimation error on the illumination superposition rate c(x), the reflected light restoration unit 21 may use a method of calculating the reflected light D₁(x,λ) such as equation (13) using a predetermined parameter k₂. Alternatively, the reflected light restoration unit 21 may use a method of calculating the reflected light D₁(x,λ) such as equation (15) using an exponential value γ calculated by using a predetermined parameter k₃ shown as equation (14).

$$\begin{matrix}{D}_{1} ( x , λ ) = \frac{{k}_{2}}{1 - c ( x )} ( I ( x , λ ) - c ( x ) \cdot A ( λ ) ) & ( 13 ) \\ γ ( x ) = \frac{{k}_{3}}{1 - c ( x )} & ( 14 ) \\ {D}_{1} ( x , λ ) = A ( λ ) \cdot ( \frac{I ( x , λ )}{A ( λ )} ) & ( 15 )\end{matrix}$$

Alternatively, as a mixed method of the calculating method of equation (13) and equation (15), the reflected light restoration unit 21 may use a minimum value Cₘᵢₙ of the illumination superposition rate c(x) calculated such as equation (16). For example, the reflected light restoration unit 21 may use a method which calculates a temporary correction result D′₁(x,λ) such as equation (17), and calculates the reflexed light D₁(x,λ) by correcting D′₁(x,λ) such as equation (19) by using exponential value γ′ determined by equation (18).

$$\begin{matrix}{c}_{min} = {min}_{∀ x} ( c ( x ) ) & ( 16 ) \\ {D}_{1}^{′} ( x , λ ) = \frac{{k}_{2}}{1 - {c}_{min}} ( I ( x , λ ) - {c}_{min} \cdot A ( λ ) ) & ( 17 ) \\ {γ}^{′} ( x ) = \frac{{k}_{3}}{1 - c ( x ) + {c}_{min}} & ( 18 ) \\ {D}_{1} ( x , λ ) = A ( λ ) \cdot {( \frac{{D}_{1}^{′} ( x , λ )}{A ( λ )} )}^{{r}^{′} ( x )} & ( 19 )\end{matrix}$$

The illumination light restoration unit 22 restores diffusion or attenuation of the illumination light illuminated to the object based on the reflected light D₁(x,λ), which is generated by the reflected light restoration unit 21, on the surface of the object. Then, the illumination light restoration unit 22 generates the output image O(x,λ) from the captured image I(x,λ) based on the illumination light restored diffusion or attenuation. As an example of generating the output image O(x,λ), there is a method which calculates the output image O(x,λ) by using a predetermined parameter k₄ such as equation (20) or a method which, such as equation (22), calculates the output image O(x,λ) by using an exponential value γ₂(x) calculated by using a predetermined parameter k₅ such as equation (21).

$$\begin{matrix}O ( x , λ ) = \frac{{k}_{4}}{1 - c ( x )} {D}_{1} ( x , λ ) & ( 20 ) \\ {γ}_{2} ( x ) = \frac{{k}_{5}}{1 - c ( x )} & ( 21 ) \\ O ( x , λ ) = A ( λ ) \cdot ( 1 - {( \frac{O ( x , λ )}{A ( λ )} )}^{{r}_{2} ( x )} ) & ( 22 )\end{matrix}$$

The first exemplary embodiment removes, for example, degradation of the image due to the particles in the air (for example, haze) in image illuminated by a lamp arranged adjacently to the image-capturing device 4 (for example, camera) under a dark environment such as at the night, or in a tunnel, and restores influence due to attenuation of the illumination light. Accordingly, the first exemplary embodiment can achieve an advantageous effect that it is possible to generate a high quality image even when capturing with using the illumination light such as the lamp.

The reason is shown in the following.

The illumination light color estimation unit 11 estimates the illumination light color A(λ). The structure component extraction unit 12 extracts the structure component B(x,λ) of the captured image. The illumination superposition rate estimation unit 13 estimates the illumination superposition rate c(x). Then, that is because the haze removal unit 14 generates the output image O(x,λ) corrected a factor of degrading the image such as the haze scene, based on the captured image I(x,λ), the illumination light color A(λ), and the illumination superposition rate c(x).

### Second Exemplary Embodiment

A second exemplary embodiment will be described.

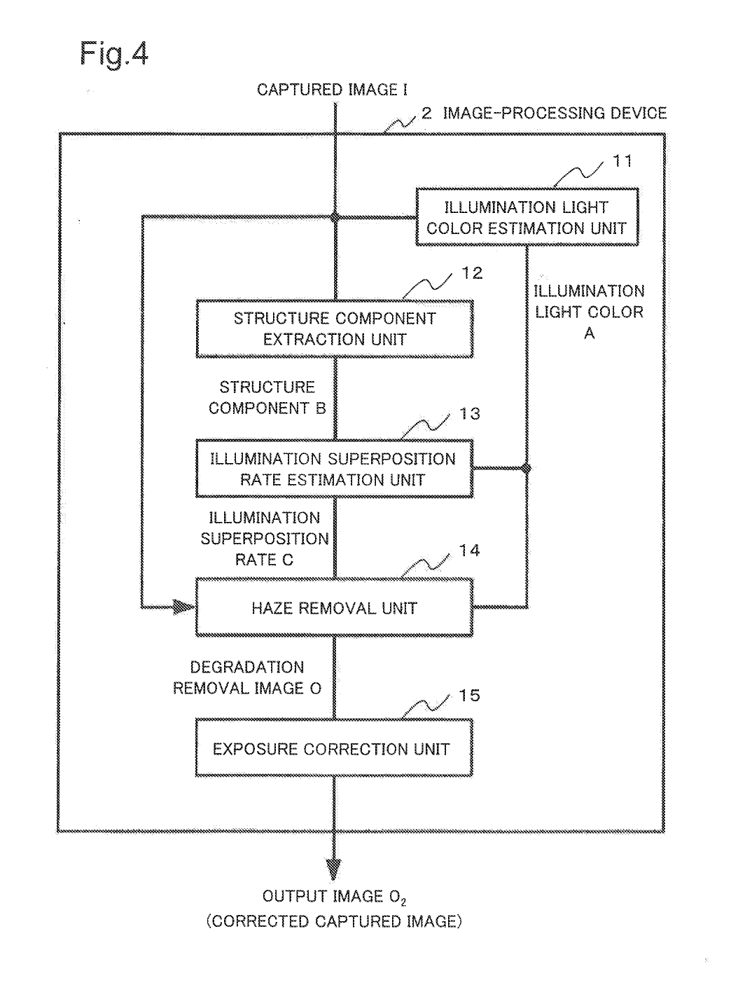

FIG. 4 is a block diagram showing an example of an image-processing device 2 according to the second exemplary embodiment of the present invention.

The image-processing device 2 according to the second exemplary embodiment includes the illumination light color estimation unit 11, the structure component extraction unit 12, the illumination superposition rate estimation unit 13, the haze removal unit 14, and an exposure correction unit 15. As mentioned above, the image-processing device 2 according to the second exemplary embodiment is different from the image-processing device 2 according to the first exemplary embodiment in a point including the exposure correction unit 15. Other components of the image-processing device 2 according to the second exemplary embodiment are similar as those of the image-processing device 2 according to the first exemplary embodiment respectively. Furthermore, the image-capturing unit 1 and the output unit 3 in the image-capturing device 4 are similar. Therefore, description of the same component is omitted, and operations of the exposure correction unit 15 which are peculiar in this exemplary embodiment will be described in the following.

The exposure correction unit 15 generates an output image O₂(x,λ) (referred to as a second output image or an exposure correction image) which is adjusted brightness of the whole image based on the output image O(x,λ) (a first output image) which is outputted from the haze removal unit 14 and is removed the degraded component. Generally, image capturing is executed with appropriate setting of a dynamic range of light quantity received by the camera sensor in the imaging environment. The correction executed by the haze removal unit 14 virtually changes the imaging environment from the captured image I(x,λ) in a hazy environment to the output image O(x,λ) in a hazy-free environment. Therefore, there is a case that the dynamic range of the first output image O(x,λ) removed the degradation component is different from the dynamic range set to the image-capturing device 4 at a time of capturing. For example, there is a case that the output image O(x,λ) removed the degradation component is too bright or too dark. Then, the exposure correction unit 15 corrects the first output image O(x,λ) removed the degradation component such as setting an appropriate dynamic range to generate the second output image O₂(x,λ). As mentioned above, the second output image O₂(x,λ) is a captured image which is corrected, and, especially, an image which is corrected exposure so as to be appropriate dynamic range.

As an example of a method in that the exposure correction unit 15 generates the second output image O₂(x,λ), there is a method that normalizes the first output image O(x,λ) based on the maximum value in the first output image O(x,λ) and generates a second output image O₂(x,λ) such as equation (23).

$${O}_{2} ( x , λ ) = \frac{O ( x , λ )}{{max}_{∀ x , λ} ( O ( x , λ ) )} \qquad ( 23 )$$

Alternatively, the exposure correction unit 15 may use an average luminance value (ave) of the first output image O(x,λ) and an average luminance value (tar) which is a predetermined target value. That is, the exposure correction unit 15 calculates the average luminance value ave of the first output image O(x,λ), and calculates an exponential value γ₃, which transforms the average luminance value ave into the average luminance value tar which is the target value such as equation (24). Then, the exposure correction unit 15 may correct the first output image O(x,λ) by using the exponential value γ₃, and generate the second output image O₂(x,λ) such as equation (25).

$$\begin{matrix}{γ}_{3} = \frac{ln ( tar )}{ln ( ave )} & ( 24 ) \\ {O}_{2} ( x , λ ) = {( O ( x , λ ) )}^{{γ}_{3}} & ( 25 )\end{matrix}$$

The second exemplary embodiment can achieve an advantageous effect that it is possible to acquire the image which has an appropriate dynamic range in addition to the advantageous effect of the first exemplary embodiment.

The reason is that the exposure correction unit 15 generates the second output image O₂(x,λ) which is appropriately corrected the dynamic range of the first output image O(x,λ).

### Third Exemplary Embodiment

A third exemplary embodiment will be described.

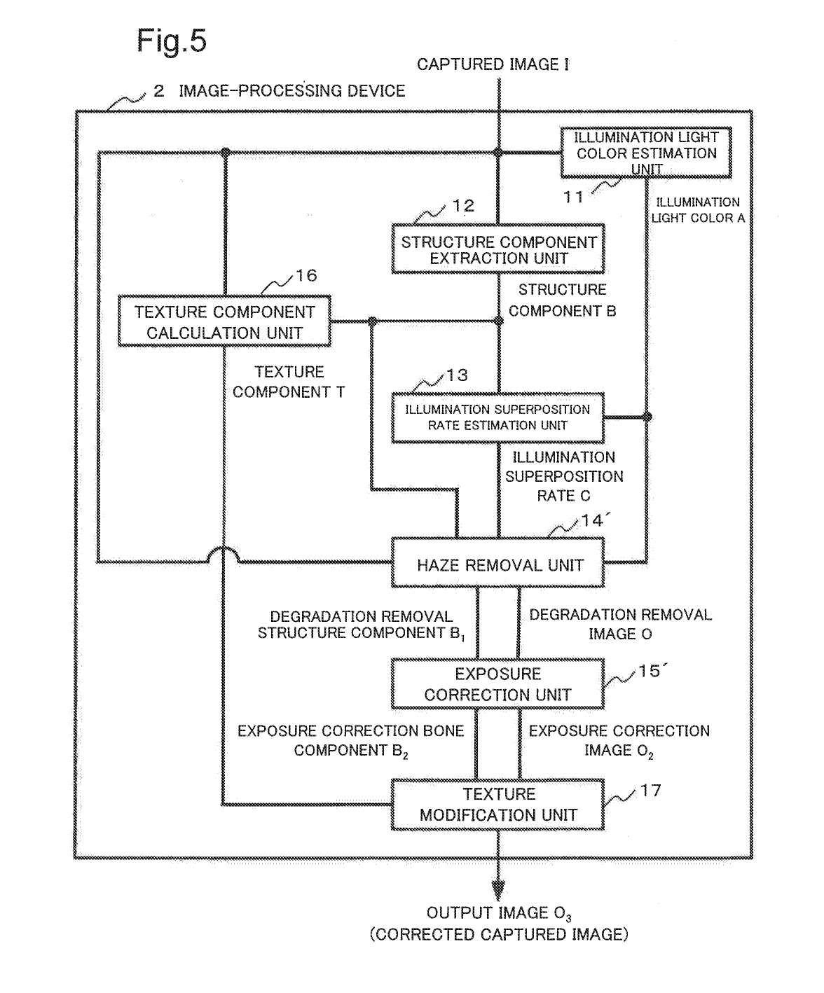

FIG. 5 is a block diagram showing an example of a configuration of an image-processing device 2 according to the third exemplary embodiment.

The image-processing device 2 according to the third exemplary embodiment includes the illumination light color estimation unit 11, the structure component extraction unit 12, the illumination superposition rate estimation unit 13, a haze removal unit 14′, an exposure correction unit 15′, a texture component calculation unit 16, and a texture component modification unit 17.

As mentioned above, the image-processing device 2 according to the third exemplary embodiment is different from the image-processing device 2 according to the second exemplary embodiment in a point that including the texture component calculation unit 16 and the texture component modification unit 17. Furthermore, the image-processing device 2 according to the third exemplary embodiment is different in a point that including the haze removal unit 14′ and the exposure correction unit 15′ instead of the haze removal unit 14 and the exposure correction unit 15. Other components of the image-processing device 2 according to the third exemplary embodiment are same as those of the image-processing device 2 according to the first or the second exemplary embodiment. The image-capturing unit 1 and the output unit 3 in the image-capturing device 4 are same. Therefore, description of the same component is omitted, and operations of the texture component calculation unit 16, the texture component modification unit 17, the haze removal unit 14′, and the exposure correction unit 15′ will be described.

The texture component calculation unit 16 calculates a component (hereinafter, defined as texture component T(x,λ)) which expresses a fine pattern (texture component or noise component) in the image and is a difference (residual) between the captured image I(x,λ) and the structure component B(x,λ), such as equation (26).

T(x,λ)=I(x,λ)−B(x,λ) (26)

The haze removal unit 14′, as same as the haze removal unit 14, generates the first output image O(x,λ) removed degradation of the image from the captured image I(x,λ). Furthermore, the haze removal unit 14′ corrects the structure component B(x,λ) (first structure component) by applying the same processing, and generates a structure component B₁(x,λ) (second structure component) removed the degraded component which is corrected. That is, the second structure component B₁(x,λ) is a structure component removed the degraded. More concretely, the illumination light restoration unit 22 executes the above-mentioned processing based on the restored illumination light.

The exposure correction unit 15′, as same as the exposure correction unit 15, generates the second output image O₂(x,λ) from the first output image O(x,λ). Furthermore, the exposure correction unit 15′ generates a structure component B₂(x,λ) (third structure component) which is corrected exposure by applying the same processing to the second structure component B₁(x,λ) removed the degraded component.

The texture component modification unit 17 restrains excessive emphasis or amplification of noise, which is generated based on the processing by the haze removal unit 14′ and the exposure correction unit 15′, of the texture within the second output image O₂(x,λ), and generates a third output image O₃(x,λ) modified the texture component. As mentioned above, the third output image O₃(x,λ) is a captured image which is corrected too.

A texture component T₂(x,λ) (second texture component) in the third output image O₃(x,λ) is calculated by using the second output image O₂(x,λ) and the exposure correction structure component B₂(x,λ) (third structure component) such as equation (27).

T₂(x,λ)=O₂(x,λ)−B₂(x,λ) (27)

As an example of a method of restraining the excessive emphasis of the texture, there is a method mentioned in the following. First, the method calculates an amplification rate r(x,λ) of the texture based on the correction processing such as equation (28). Then, the method calculates a texture component T₃(x,λ) (third texture component) restrained excessive emphasis by using a predetermined upper limit value of the amplification rate rₘₐₓ such as equation (29).

$$\begin{matrix}r ( x , λ ) = \frac{{T}_{2} ( x , λ )}{T ( x , λ )} & ( 28 ) \\ {T}_{3} ( x , λ ) = \{ \begin{matrix}{T}_{2} ( x , λ ) & if r ( x , λ ) < {r}_{max} \\ {r}_{max} \cdot T ( x , λ ) & otherwise\end{matrix} & ( 29 )\end{matrix}$$

Alternatively, as a method of restraining the noise included in the texture component, there is a method expressed as equation (30). The method expressed as equation (30) removes vibration based on the noise from the third texture component T₃(x,λ) by using a standard deviation a of the noise calculated from a feature of camera and an amplification rate of the texture, and generates a texture component T₄(x,λ) (fourth texture component) which is restrained noise. However, sgn(.) is a function which indicates a sign.

$${T}_{4} ( x , λ ) = \{ \begin{matrix}0 & if \vert {T}_{3} ( x , λ ) \vert < σ ( x , λ ) \\ sgn ( {T}_{3} ( x , λ ) ) \cdot ( \vert {T}_{3} ( x , λ ) \vert - σ ( x , λ ) ) & otherwise\end{matrix} \qquad ( 30 )$$

The texture component modification unit 17 generates a third output image O3(x,λ) by combining the third structure component B2(x,λ) with the fourth texture component T4(x,λ) such as equation (31).

O₃(x,λ)=B₂(x,λ)+T₄(x,λ) (31)

The third exemplary embodiment can achieve an advantageous effect that it is possible acquire the image which is restrained the excessive emphasis and the amplification of the noise of the texture in addition to the advantageous effects of the first and the second exemplary embodiments.

The reason is as follows.

The texture component calculation unit 16 calculates the first texture component T(x,λ). The haze removal unit 14′ generates the second structure component B₁ (x,λ) corrected degradation of the in addition to the first output image O(x,λ). The exposure correction unit 15′ generates the third structure component B₂(x,λ) corrected exposure based on the second structure component in addition to the second output image O₂(x,λ).

Then, the texture component modification unit 17 calculates the second texture component T₂(x,λ) based on the second output image O₂(x,λ) and the third structure component B₂(x,λ). Furthermore, in order to restrain the excessive emphasis, the texture component modification unit 17 calculates the third texture component T₃(x,λ) based on the first texture component T₁(x,λ) and the second texture component T₂(x,λ). Furthermore, the texture component modification unit 17 calculates the fourth texture component T₄(x,λ) restrained the vibration due to the noise in the third texture component T₃(x,λ). Then, that is because the texture component modification unit 17 generates the third output image O₃(x,λ) which is restrained the excessive emphasis or the amplification of the noise of texture based on the third structure component B₂(x,λ) and the fourth texture component T₄(x,λ).

### Fourth Exemplary Embodiment

A fourth exemplary embodiment will be described.

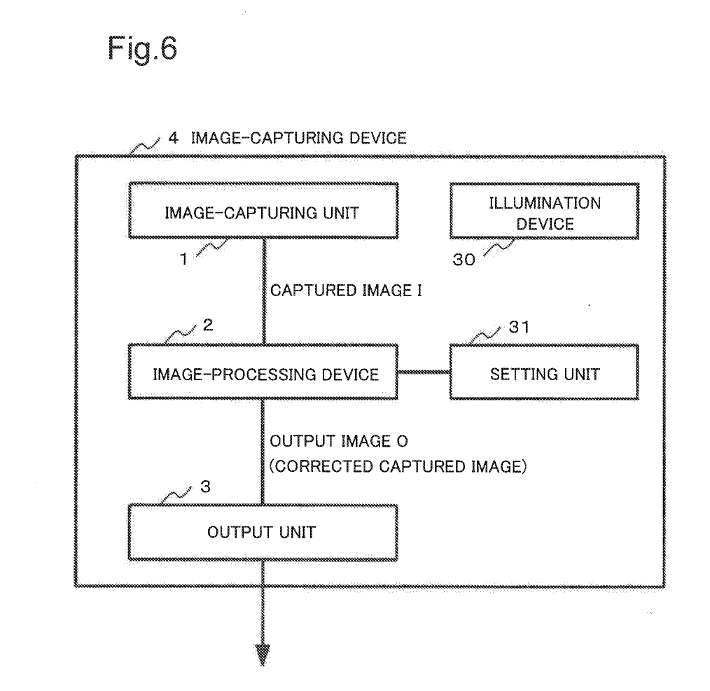

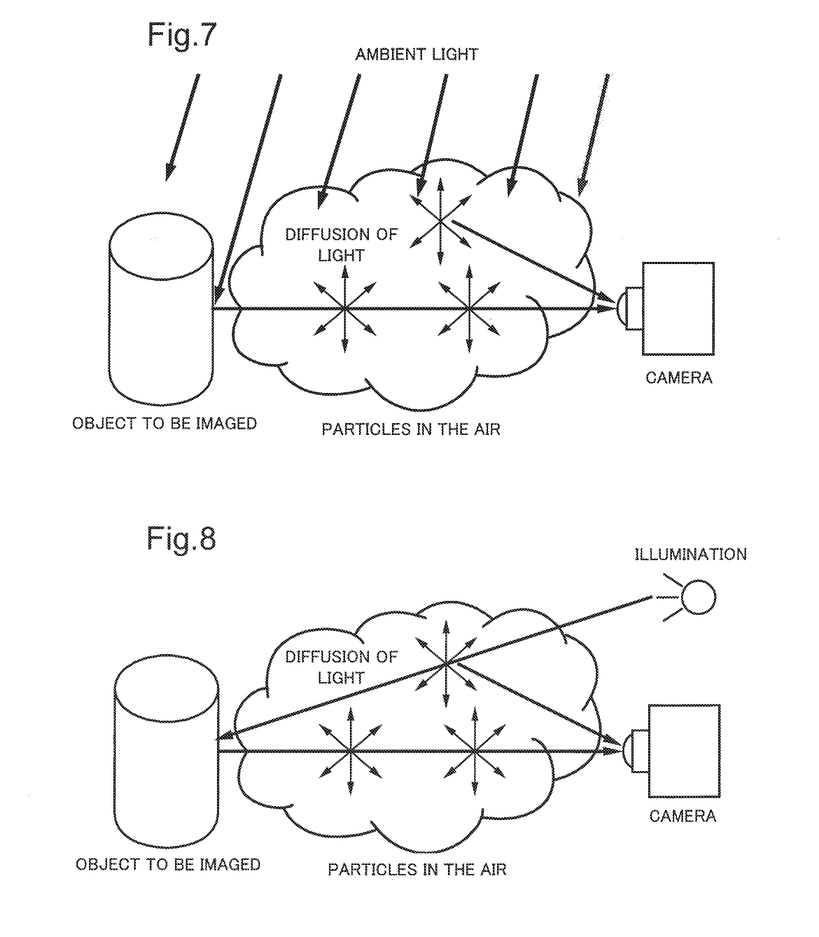

FIG. 6 is a block diagram showing an example of a configuration of an image-capturing device 4 according to the fourth exemplary embodiment.

A point that the image-capturing device 4 according to the fourth exemplary embodiment is different from the image-capturing device 4 in the first to the third exemplary embodiments is a point that the image-capturing device 4 according to the fourth exemplary embodiment includes an illumination device 30 and a setting unit 31. Since other components of the image-capturing device 4 according to the fourth exemplary embodiment are same as those of the image-capturing device 4 according to the first to the third exemplary embodiments, description of the same components is omitted, and the illumination device 30 and the setting unit 31 will be described.

The illumination device 30 is arranged at adjacent position to the image-capturing unit 1, and illuminates the illumination light to object to be imaged with start of capturing. The illumination device 30 is, for example, a flash-lamp.

The setting unit 31 switches between an execution setting and a suspension setting of correcting processing for image degradation (for example, the haze or the like) in the image-processing device 2. In capturing under a hazy environment, there is a case intentionally making the haze reflected in a captured image. In this case, by using the setting unit 31, the user of the image-capturing device 4 can suspend the correcting processing for degradation of image in the image-processing device 2.

In the image-capturing device 4 according to the fourth exemplary embodiment, the illumination device 30 is arranged at the position adjacent to the image-capturing unit 1. Therefore, the captured image under the illumination light by the illumination device 30 tends to receive influence of particles in the air. However, the image-processing device 2 of the fourth exemplary embodiment can achieve an advantageous effect that it is possible to appropriately correct influence of the haze in the captured image.

The reason is that the image-processing device 2 of the image-capturing device 4 can generate the output images (the first output image O(x,λ) to the third output image O₃(x,λ)) corrected the influence of the particles in the air based on the operations described in the first to the third exemplary embodiments.

Furthermore, the image-capturing device 4 according to the fourth exemplary embodiment can achieve advantageous effect of generating an image intentionally reflected the haze or the like.

The reason is as follows. The image-capturing device 4 according to the fourth exemplary embodiment includes the setting unit 31 which suspends the correcting processing for degradation of the image in the image-processing device 2. Accordingly, that is because the user can suspend the correcting processing for degradation of the image by using the setting unit 31, and can intentionally make degradation of the image due to the haze or the like reflected in the captured image.

Here, it is needless to say that the above-mentioned first to the fourth exemplary embodiments are applicable to not only a still image but also a moving image.

Moreover, it is possible to install the image-processing devices 2 according to the first to the fourth exemplary embodiments in various kinds of capturing equipment or various kinds of devices processing the image, as an image processing engine.

<Modification>

The image-processing devices 2 or the image capturing devices 4 according to the first to the fourth exemplary embodiments are configured as shown in the following.

For example, each of components of the image-processing devices 2 or the image-capturing devices 4 may be configured with a hardware circuit.

Alternatively, in the image-processing device 2 or the image capturing device 4, each of components may be configured by using a plurality of devices which are connected through a network.

For example, the image-processing device 2 of FIG. 2 may be configured so as to be a device which includes the haze removal unit 14 shown in FIG. 3 and is connected with a device including the illumination light color estimation unit 11, a device including the structure component extraction unit 12, and a device including the illumination superposition rate estimation unit 13 through a network. In this case, the image-processing device 2 should receive the captured image I(x,λ), the illumination superposition rate c(x), and the illumination light color A(λ) through the network, and generate the first output image I(x,λ) based on the above-mentioned operations. As above-mentioned, the haze removal unit 14 shown in FIG. 3 is the minimum configuration of the image-processing device 2.

Alternatively, in the image-processing device 2 or the image capturing device 4, a plurality of components may be configured with single hardware.

Alternatively, the image-processing device 2 or the image-capturing device 4 may be realized as a computer device which includes a Central Processing Unit (CPU), a Read Only Memory (ROM), and a Random Access Memory (RAM). Furthermore, the image-processing device 2 or the image capturing device 4 may be realized as a computer device which includes an Input and Output Circuit (IOC) and a Network Interface Circuit (NIC) in addition to the above-mentioned components.

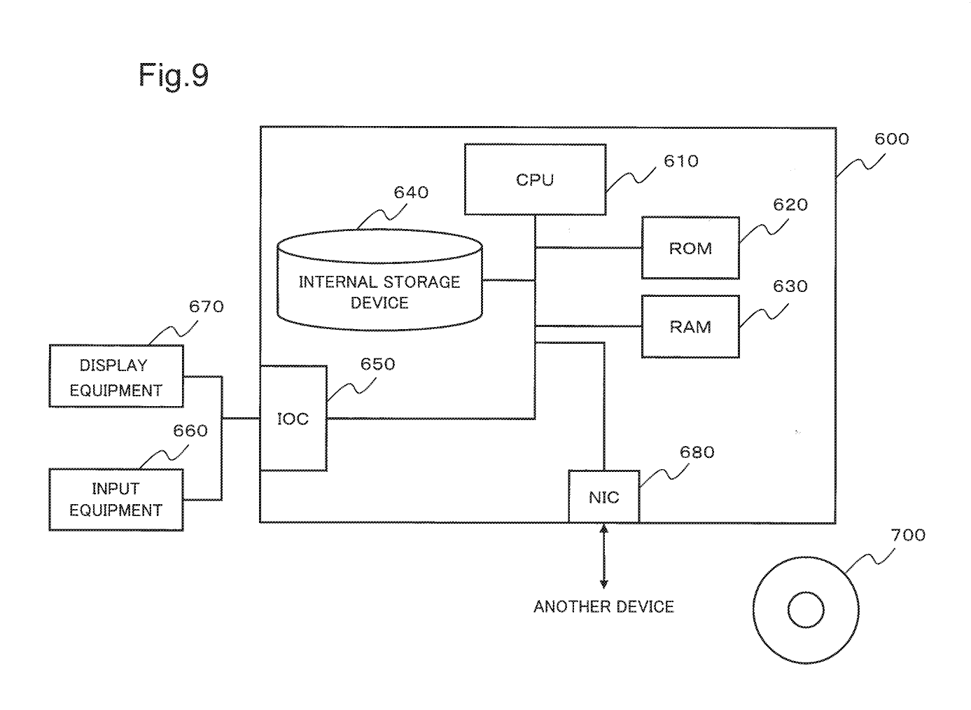

FIG. 9 is a block diagram showing an example of configuration of an information-processing device 600 according to the present modification as the image-processing device 2 or the image capturing device 4.

The information-processing device 600 includes a CPU 610, a ROM 620, a RAM 630, an internal storage device 640, an IOC 650, and a NIC 680 to configure a computer device.

The CPU 610 reads out a program from the ROM 620. Then, the CPU 610 controls the RAM 630, the internal storage device 640, the IOC 650, and the NIC 680 based on the read program. Then, the computer device including the CPU 610 controls the components, and realizes each function as each component shown in FIG. 1 to FIG. 6.

When realizing each function, the CPU 610 may use the RAM 630 or the internal storage device 640 as a temporary storage of the program.

Alternatively, the CPU 610 may read out the program included in a storage medium 700 which stores the program so as to be computer-readable, by using a storage medium reading device not shown in the drawing. Alternatively, the CPU 610 receives the program from an external device not shown in the drawing through the NIC 680, and stores the program into the RAM 630, and operates based on the stored program.

The ROM 620 stores the program executed by the CPU 610, and fixed data. The ROM 620 is, for example, a programmable-ROM (P-ROM), or a flash ROM.

The RAM 630 temporarily stores the program executed by the CPU 610, and data. The RAM 630 is, for example, a dynamic-RAM (D-RAM).

The internal storage device 640 stores data and the program which the information-processing device 600 stores for a long period. Furthermore, the internal storage device 640 may operate as a temporary storage device of the CPU 610. The internal storage device 640 is, for example, a hard disc device, a magneto-optical disc device, SSD (Solid State Drive), or a disc array device.

Here, the ROM 620 and the internal storage device 640 are a non-transitory storage media. Meanwhile, the RAM 630 is a transitory storage medium. The CPU 610 can execute based on the program which the ROM 620, the internal storage device 640, or the RAM 630 stores. That is, the CPU 610 can execute by using the non-transitory storage medium or the transitory storage medium.

The IOC 650 mediates data between the CPU 610 and an input equipment 660, and between the CPU 610 and a display equipment 670. The IOC 650 is, for example, an I/O interface card, or a USB (Universal Serial Bus) card.

The input equipment 660 is equipment which receives an input instruction from an operator of the information-processing device 600. The input equipment is, for example, a keyboard, a mouse, or a touch panel.

The display equipment 670 is equipment which displays information for the operator of the information-processing device 600. The display equipment 670 is, for example, a liquid-crystal display.

The NIC 680 relays data communication with an external device, which is not shown in the drawing, through a network. The NIC 680 is, for example, a local area network (LAN) card.

The information-processing device 600 which is configure in this manner can achieve an advantageous as same as the image-processing device 2 or the image-capturing device 4.

The reason is that the CPU 610 of the information-processing device 600 can realize same functions of the image-processing device 2 or the image capturing device 4 based on the program.

The whole or part of the exemplary embodiments disclosed above can be described as, but not limited to, the following supplementary notes.

(Supplementary Note 1)

An image-processing device includes:

a reflected light restoration unit that restores reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and an illumination light restoration unit that restores the illumination light based on the restored reflected-light, and generates a first output image in which the captured image is restored based on the restored illumination light and the captured image.

(Supplementary Note 2)

The image-processing device according to supplementary note 1 includes:

an illumination light color estimation unit that estimates the illumination light color;

a structure component extraction unit that extracts a first structure component indicating comprehensive structure of the captured image; and

an illumination superposition rate estimation unit that estimates the illumination superposition rate based on the estimated illumination light color and the first structure component.

(Supplementary Note 3)

The image-processing device according to supplementary note 2 includes:
an exposure correction unit that generates a second output image based on correction of adjusting brightness of the first output image.

(Supplementary Note 4)

The image-processing device according to supplementary note 3 includes:

a texture component calculation unit that calculates a first texture component which is a difference between the captured image and the first structure component, wherein

the illumination light restoration unit generates a second structure component in which the first structure component is corrected based on the restored illumination light, and

the exposure correction unit generates a third structure component by correcting exposure of the second structure component, wherein

the image-processing device further including:

a texture component modification unit that calculates a second texture component based on the second output image and the third structure component, calculates a third texture component in which excessive emphasis is restrained based on the first texture component and the second texture component, calculates a fourth texture component in which vibration of the third texture component is restrained, and generates a third output component by modifying the second output image based on the fourth texture component and the third structure component.

(Supplementary Note 5)

An image-capturing device includes:

the image-processing device according to any one of supplementary notes 1 to 4;

a reception unit that captures or receives the captured image; and

an output unit that outputs the first to the third output images.

(Supplementary Note 6)

The image-capturing device according to supplementary note 5 includes:

an illumination unit that illuminates the illumination light; and

a setting unit that switches settings of an execution and a suspension of correcting process to the captured image in the image-processing device.

(Supplementary Note 7)

An image-processing method includes:

restoring reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and

restoring the illumination light based on the restored reflected-light, and generating a first output image in which the captured image is restored based on the restored illumination light and the captured image.

(Supplementary Note 8)

A computer readable non-transitory storage medium embodying a program, the program causing a computer to perform a method, the method comprising:

restoring reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and

restoring the illumination light based on the restored reflected-light, and generating a first output image in which the captured image is restored based on the restored illumination light and the captured image.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1 Image-capturing unit
2 Image-processing device
3 Output unit
4 Image-capturing device
11 Illumination light color estimation unit
12 Structure component extraction unit
13 Illumination superposition rate estimation unit
14 Haze removal unit
14′ Haze removal unit
15 Exposure correction unit
15′ Exposure correction unit
16 Texture component calculation unit
17 Texture component modification unit
21 Reflected light restoration unit
22 Illumination light restoration unit
30 Illumination device
31 Setting unit
600 Information-processing device
610 CPU
620 ROM
630 RAM
640 Internal storage device
650 IOC
660 Input equipment
670 Display equipment
680 NIC
700 Storage medium

What is claimed is:

1. An image-processing device comprising:
a reflected light restoration unit that restores reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and
an illumination light restoration unit that restores the illumination light based on the restored reflected-light, and generates a first output image in which the captured image is restored based on the restored illumination light and the captured image.

2. The image-processing device according to claim 1 comprising:
an illumination light color estimation unit that estimates the illumination light color;
a structure component extraction unit that extracts a first structure component indicating comprehensive structure of the captured image; and
an illumination superposition rate estimation unit that estimates the illumination superposition rate based on the estimated illumination light color and the first structure component.

3. The image-processing device according to claim 2 comprising:
an exposure correction unit that generates a second output image based on correction of adjusting brightness of the first output image.

4. The image-processing device according to claim 3 comprising:
a texture component calculation unit that calculates a first texture component which is a difference between the captured image and the first structure component, wherein
the illumination light restoration unit generates a second structure component in which the first structure component is corrected based on the restored illumination light, and
the exposure correction unit generates a third structure component by correcting exposure of the second structure component, wherein
the image-processing device further including:
a texture component modification unit that calculates a second texture component based on the second output image and the third structure component, calculates a third texture component in which excessive emphasis is restrained based on the first texture component and the second texture component, calculates a fourth texture component in which vibration of the third texture component is restrained, and generates a third output component by modifying the second output image based on the fourth texture component and the third structure component.

5-6. (canceled)

7. An image-processing method, comprising:
restoring reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and
restoring the illumination light based on the restored reflected-light, and generating a first output image in which the captured image is restored based on the restored illumination light and the captured image.

8. A computer readable non-transitory storage medium embodying a program, the program causing a computer to perform a method, the method comprising:
restoring reflected light on a surface of an object to be imaged, based on a captured image of the object, an illumination superposition rate indicating a degree of influence of attenuation or diffusion based on particles in the air of illumination light in the captured image, and an illumination light color that is information of a color of the illumination light; and
restoring the illumination light based on the restored reflected-light, and generating a first output image in which the captured image is restored based on the restored illumination light and the captured image.
